(19) United States
(12) Patent Application Publication
(10) Pub. No.: US 2023/0017294 A1
(43) Pub. Date: Jan. 19, 2023

(54) FLOCCULATING AGENT FOR REMOVING OIL-BASED DRILLING FLUID ROCK CUTTINGS AND PREPARATION METHOD AND USE THEREOF

(71) Applicant: China University of Petroleum (East China), Qingdao (CN)

(72) Inventors: Jinsheng SUN, Qingdao (CN); Kaihe Lv, Qingdao (CN); Xianbin Huang, Qingdao (CN); Yuan Geng, Qingdao (CN); Jingping Liu, Qingdao (CN); Yingrui Bai, Qingdao (CN); Jintang Wang, Qingdao (CN); Jiafeng Jin, Qingdao (CN)

(73) Assignee: China University of Petroleum (East China), Qingdao (CN)

(21) Appl. No.: 17/857,390

(22) Filed: Jul. 5, 2022

(30) Foreign Application Priority Data
Jul. 8, 2021 (CN) 202110771466.1

(51) Int. Cl. C09K 8/34

(52) U.S. Cl. CPC C09K 8/34

(57) ABSTRACT

The present disclosure relates to the technical field of oilfield chemistry. A flocculating agent for removing oil-based drilling fluid rock cuttings and a preparation method and a use thereof.

### CROSS REFERENCE TO RELATED APPLICATIONS

The application claims priority to Chinese Application No. 202110771466.1, filed on Jul. 8, 2021, entitled “flocculating agent for removing oil-based drilling fluid rock cuttings and preparation method and use thereof”, which is herein specifically and entirely incorporated by reference.

### FIELD

The present disclosure relates to the technical field of oilfield chemistry, in particular to a flocculating agent for removing oil-based drilling fluid rock cuttings and a preparation method and a use thereof.

### BACKGROUND

China's dependence on foreign crude oil and natural gas has reached 72.8% and 45.3% in 2020, respectively. The excessively high dependence on foreign energy resources has imposed more stringent requirements on the exploration and development of domestic oil and gas, it has become a big trend that the exploration and development of domestic oil and gas will shift from regular oil and gas resources to non-regular oil and gas resources, and from the shallow stratum to the deep stratum. During the development of the oil and gas resources, the geological situations of drilling wells have become increasingly complicated and rigorous, which put increasingly higher demands on the technologies of drilling fluids.

The oil-based drilling fluids are oil-water emulsion systems with an external phase of oil. The oil-based drilling fluids having the advantages of strong inhibition, high temperature resistance and desirable lubrication, are widely used in complex geological situations such as water-sensitive formations, deep-seated high temperature and high pressure formations. The oil-based drilling fluids have emerged as the preferred drilling fluids for deep wells, high temperature wells, horizontal wells and the like.

During an operation process using the oil-based drilling fluids, a part of the drill cuttings is subjected to repeated grinding inside the well due to the reasons such as long horizontal segment, poor cuttings carrying capacity of oil-based drilling fluids, limited performance of a solid control equipment, in particular, a small amount of rock cuttings which is not removed by the solid control equipment again moves from the wellhead to the borehole, and the particle size of the rock cuttings is greatly reduced to the micro-nanometer scale after subjecting to a high speed shearing at the drill bit, which eventually causes the rock cuttings content in the oil-based drilling fluid system to be generally and excessively high and the rock cuttings cannot be easily removed, so that the viscosity of the oil-based drilling fluids are too high, which brings about the problems such as the long well construction cycle, excessive surge pressure during a process of drilling, deteriorated lubricity, increased filtrate loss, or even causes an incident of borehole instability in severe cases.

The current methods for reducing the content of rock cuttings in oil-based drilling fluids are primarily performed through solid control equipment and dilution method (using water-in-oil emulsion). The existing solid control equipment can effectively remove the drilling cuttings with a large particle size, but has little effect on the micro-nanometer scale rock cuttings. The main factor contributing to the excessive viscosity of oil-based drilling fluids is micro-nanometer scale rock cuttings. The dilution method may reduce the content of fine rock cuttings temporarily by introducing and adding water-in-oil emulsion, but the fine rock cuttings is not substantially removed, the viscosity and shearing force will still increase too rapidly over a period of time, resulting in a deterioration of drilling fluid performance. Furthermore, the dilution method is costly, and the excessive volume of drilling fluid after the dilution may cause a series of problems such as high disposal costs of the drilling fluid in the future.

CN109652026A discloses a preparation method of a flocculation type flow pattern regulator for an oil-based drilling fluid. The preparation method comprises the following steps: (1) adding nanometer activated carbon into a beaker provided with a stirrer and a thermometer; (2) adding a low-viscosity synthetic base oil in an amount of 1-40% by weight into a reactor in the step (1), and performing stirring at 50-90° C. for 3-6 h; (3) adding an emulsifier in an amount of 1-5% by weight into the reactor in the step (1), and performing stirring for 3-6 h; and (4) adding a wetting agent in an amount of 1-10% by weight into the reactor in the step (1), and performing stirring for 3-5 h to obtain a turbid liquid, which is exactly the flocculation type flow pattern regulator for the oil-based drilling fluids. The method can reduce the content of finely dispersed particles in oil-based drilling fluids, but the flocculation effect is relatively limited, and there is also flocculation effect on the useful solid phase such as barite and organic clay in oil-based drilling fluids, which also limits its use in high density oil-based drilling fluids.

To sum up, it would be highly indispensable to prepare a flocculating agent that can be used for selective removal of rock cuttings from oil-based drilling fluids.

### SUMMARY

The purpose of the present disclosure is to overcome the defects in the prior art that the removal effect of inferior solid phase in oil-based drilling fluids is not sufficiently desirable and that the flocculation of the useful solid phase in the drilling fluids is also carried out during the process of removing the inferior solid phase, and provides a flocculating agent for removing oil-based drilling fluid rock cuttings and a preparation method and a use thereof.

In order to fulfill the above purpose, a first aspect of the present disclosure provides a flocculating agent for removing oil-based drilling fluid rock cuttings prepared from a prepolymer-A and a prepolymer-B through a graft polymerization reaction in the presence of a third solvent;

wherein the prepolymer-A is prepared by subjecting a hydrophilic monomer, a cationic monomer and glycidyl methacrylate to a first polymerization reaction in the presence of a first solvent and a first initiator; and

the prepolymer-B is prepared by subjecting an oil-soluble monomer, acrylamide and 2-aminoethanethiol hydrochloride to a second polymerization reaction in the presence of a dispersing agent, a second solvent and a second initiator.

In a second aspect, the present disclosure provides a method of preparing a flocculating agent of the aforesaid first aspect comprising:

(1) subjecting a hydrophilic monomer, a cationic monomer, and glycidyl methacrylate to a first dissolution with a first solvent to obtain solution-a;

(2) adding a first initiator into the solution-a for performing a first polymerization reaction to obtain prepolymer-A;

(3) subjecting the dispersing agent to a second dissolution with a second solvent to obtain solution-b;

(4) adding an oil-soluble monomer, acrylamide and 2-aminoethanethiol hydrochloride into the solution-b and mixing the compounds, then adding a second initiator to perform a second polymerization reaction to obtain prepolymer-B;

(5) dissolving the prepolymer-A and the prepolymer-B in a third solvent to perform a graft polymerization reaction to produce a flocculating agent.

In a third aspect, the present disclosure provides a use of the flocculating agent of the aforesaid first aspect in the oil-based drilling fluids.

Due to the above-mentioned technical schemes, the flocculating agent provided by the present disclosure has the following favorable effects:

(1) The flocculating agent has the property of selectively flocculating inferior solid phase, it has relatively weak flocculating effect on the useful solid phase such as barite and organic clay, and can be used in the oil-based drilling fluids with a high density;

(2) The particle size of the inferior solid phase in the oil-based drilling fluids can be significantly increased, the plastic viscosity and final shear force value of the drilling fluids can be significantly decreased, and after further combined with the centrifugation measures, the content of inferior solid phase in the oil-based drilling fluids can be obviously reduced.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point value of the various ranges, and the individual point values may be combined with one another to produce one or more new numerical ranges, which should be deemed have been specifically disclosed herein.

The specific embodiments of the present disclosure are described below in details. It should be comprehended that the specific embodiments described herein merely serve to illustrate and explain the present disclosure, instead of imposing limitation thereto.

In a first aspect, the present disclosure provides a flocculating agent for removing oil-based drilling fluid rock cuttings prepared from a prepolymer-A and a prepolymer-B through a graft polymerization reaction in the presence of a third solvent;

wherein the prepolymer-A is prepared by subjecting a hydrophilic monomer, a cationic monomer and glycidyl methacrylate to a first polymerization reaction in the presence of a first solvent and a first initiator; and

the prepolymer-B is prepared by subjecting an oil-soluble monomer, acrylamide and 2-aminoethanethiol hydrochloride to a second polymerization reaction in the presence of a dispersing agent, a second solvent and a second initiator.

In some embodiments of the present disclosure, the oil-soluble monomer is preferably at least one selected from the group consisting of styrene, vinylcyclohexane and methacrylamide hexadecyl ester, further preferably methacrylamide hexadecyl ester and/or styrene, such that the produced flocculating agent has desirable solubility in the oil-based drilling fluids.

In some embodiments of the present disclosure, the cationic monomer is preferably at least one selected from the group consisting of N-2(acrylamido methoxy) ethyl trimethyl ammonium chloride, methacryloxyethyl trimethyl ammonium chloride, acryloxyethyl trimethyl ammonium chloride, dimethyl diallyl ammonium chloride, vinyl pyridine and octadecyl dimethyl allyl ammonium chloride, further preferably acryloxyethyl trimethyl ammonium chloride and/or dimethyl diallyl ammonium chloride, such that the produced flocculating agent has desired adsorption and flocculation capacity on the rock cuttings in the oil-based drilling fluids.

In some embodiments of the present disclosure, the hydrophilic monomer is preferably at least one selected from the group consisting of acrylamide, acrylic acid, sodium allylsulfonate and 2-acrylamido-2-methylpropane sulfonic acid, further preferably 2-acrylamido-2-methylpropane sulfonic acid and/or sodium allylsulfonate, such a hydrophilic monomer can improve the degree of branching in the flocculating agent structure, thereby causing that the prepared flocculating agent has desirable adsorption and flocculation capacity for the rock cuttings in the oil-based drilling fluids.

In some embodiments of the present disclosure, the first solvent and the second solvent are the same, each may be selected from methanol, ethanol, dimethylsulfoxide or isopropanol; preferably, both the first solvent and the second solvent are methanol.

In the present disclosure, the third solvent may be methanol, ethanol or isopropanol, preferably methanol.

In the present disclosure, the dispersing agent may be hydroxypropyl cellulose or polyvinyl alcohol.

In the present disclosure, the first initiator and the second initiator are the same, each may be selected from azobisisobutyronitrile or dibenzoyl peroxide; preferably, both the first initiator and the second initiator are azobisisobutyronitrile.

In some embodiments of the present disclosure, the raw materials for preparing prepolymer-A meet the following condition: the cationic monomer is 10-40 parts by weight, the glycidyl methacrylate is 5-20 parts by weight, the first solvent is 300-800 parts by weight, the first initiator is 0.1-0.5 parts by weight, based on 100 parts by weight of the hydrophilic monomer; the raw materials for preparing prepolymer-B meet the following condition: acrylamide is 10-40 parts by weight, 2-aminoethanethiol hydrochloride is 0.1-2 parts by weight, the second solvent is 300-800 parts by weight, the dispersing agent is 5-25 parts by weight, the second initiator is 0.1-0.5 parts by weight, based on 100 parts by weight of the oil-soluble monomer.

In the present disclosure, under the premise that the ingredients of the raw materials used for the preparation of the flocculating agent meet the aforementioned quantitative relationship, in order to produce a flocculating agent for removing oil-based drilling fluid rock cuttings having better flocculation effect, it is preferable that the raw materials for preparing prepolymer-A meet the following condition: the cationic monomer is 15-25 parts by weight, the glycidyl methacrylate is 10-15 parts by weight, the first solvent is 400-550 parts by weight, the first initiator is 0.25-0.3 parts by weight, based on 100 parts by weight of the hydrophilic monomer; the raw materials for preparing prepolymer-B meet the following condition: acrylamide is 20-30 parts by weight, 2-aminoethanethiol hydrochloride is 0.5-1 parts by weight, the second solvent is 400-550 parts by weight, the dispersing agent is 10-15 parts by weight, the second initiator is 0.25-0.3 parts by weight, based on 100 parts by weight of the oil-soluble monomer.

In some embodiments of the present disclosure, in order to obtain a better selective flocculation effect, the mass ratio of prepolymer-A:prepolymer-B is preferably 1:(1-5), further preferably 1:(1-2); the mass ratio of (prepolymer-A+prepolymer-B):the third solvent is preferably (1-4):10, further preferably (2-3):10.

In a second aspect, the present disclosure provides a method of preparing a flocculating agent of the aforesaid first aspect comprising:

(1) subjecting a hydrophilic monomer, a cationic monomer, and glycidyl methacrylate to a first dissolution with a first solvent to obtain solution-a;

(2) adding a first initiator into the solution-a for performing a first polymerization reaction to obtain prepolymer-A;

(3) subjecting the dispersing agent to a second dissolution with a second solvent to obtain solution-b;

(4) adding an oil-soluble monomer, acrylamide and 2-aminoethanethiol hydrochloride into the solution-b and mixing the compounds, then adding a second initiator to perform a second polymerization reaction to obtain prepolymer-B;

(5) dissolving the prepolymer-A and the prepolymer-B in a third solvent to perform a graft polymerization reaction to produce a flocculating agent.

In the present disclosure, room temperature refers to 20-30° C.

In some embodiments of the present disclosure, in order to sufficiently dissolve the hydrophilic monomer, cationic monomer and glycidyl methacrylate in the first solvent, thereby produce the uniform and stable solution-a in step (1), the condition of the first dissolution preferably comprises that temperature may be room temperature, and the stirring rate may be within a range of 1,000-2,000 rpm.

In some embodiments of the present disclosure, the condition of the first polymerization reaction in step (2) preferably comprises that the temperature may be 50-85° C., the time may be 7-12 h, and the stirring rate may be within a range of 300-500 rpm.

In some embodiments of the present disclosure, in order to sufficiently dissolve the dispersing agent in the second solvent, the condition of the second dissolution in step (3) preferably comprises that the temperature may be room temperature, and the stirring rate may be within a range of 1,000-2,000 rpm;

In some embodiments of the present disclosure, the condition of mixing in step (4) preferably comprises that the temperature may be room temperature, and the stirring rate may be within a range of 1,000-2,000 rpm.

In the present disclosure, the condition of the second polymerization reaction comprises that the temperature may be 45-80° C., the time may be 10-24 hours, and the stirring rate may be within a range of 300-500 rpm.

In some embodiments of the present disclosure, for the sake of ensuring smooth running of the first polymerization reaction and the second polymerization reaction in step (2) and step (4), it is preferable to introduce an inert shielding gas into the reaction system before adding of the first initiator or the second initiator, so as to avoid interference of the oxygen on the reaction. The inert shielding gas may be an inert gas such as nitrogen, helium, argon, preferably nitrogen.

In some embodiments of the present disclosure, the condition of the graft polymerization reaction preferably comprises that the temperature may be room temperature, the time may be 20-48 h, and the stirring rate may be within a range of 300-500 rpm.

In some embodiments of the present disclosure, the step (2), the step (4) and the step (5) respectively comprises the process of subjecting the product of the first polymerization reaction, the product of the second polymerization reaction, and the product of the graft polymerization reaction to drying and pulverizing, so as to produce the prepolymer-A, the prepolymer-B and the flocculating agent in the powder form. The drying condition preferably comprises that the temperature may be 85-105° C., and the time may be 24-72 hours.

In the present disclosure, the produced flocculating agent, which is a yellowish viscous liquid, has excellent solubility properties in the oil-based drilling fluids; on this basis, the flocculating agent has the property of selectively flocculating the inferior solid phase in the oil-based drilling fluids, and has weaker flocculation effect on the useful solid phases such as barite and organic clay, it can significantly improve the effect of removing rock cuttings from the oil-based drilling fluids.

In a third aspect, the present disclosure provides a use of the flocculating agent of the aforesaid first aspect in the oil-based drilling fluids.

The present disclosure will be described in detail below with reference to examples. In the following Examples and Comparative Examples:

Unless otherwise specified, the materials used herein are commercially available conventional materials.

### Example 1

(1) 100 g of 2-acrylamido-2-methylpropane sulfonic acid, 20 g of acryloxyethyl trimethyl ammonium chloride and 15 g of glycidyl methacrylate were dissolved in 450 g of methanol under the condition of room temperature and a stirring rate of 2,000 rpm to obtain solution-a;

(2) the solution-a was placed in a three-port flask, and nitrogen gas was continuously introduced into the three-port flask for 30 min, 0.3 g of azobisisobutyronitrile was then added to carry out a first polymerization reaction under the reaction condition that the temperature was 65° C., the time was 10 hours, and the stirring rate was 500 rpm. The product of the first polymerization reaction was dried at 85° C. for 24 hours, and subsequently pulverized to obtain prepolymer-A;

(3) 13 g of hydroxypropyl cellulose was dissolved in 400 g of methanol under the condition of room temperature and a stirring rate of 2,000 rpm to obtain solution-b;

(4) 100 g of methacrylamide hexadecyl ester, 25 g of acrylamide and 0.5 g of 2-aminoethanethiol hydrochloride were added into solution-b, and mixed under the condition of room temperature and a stirring rate of 2,000 rpm, the mixture was then placed in a three-port flask, nitrogen gas was continuously introduced for 30 min, 0.3 g of azobisisobutyronitrile was subsequently added to perform a second polymerization reaction under the reaction condition that the temperature was 60° C., the time was 12 hours, and the stirring rate was 500 rpm. The product of the second polymerization reaction was dried at 85° C. for 24 hours, and subsequently pulverized to obtain prepolymer-B;

(5) 10 g of prepolymer-A and 20 g of prepolymer-B were weighed (i.e., the mass ratio of prepolymer-A:prepolymer-B was 1:2) and dissolved in 100 g of methanol to carry out a graft polymerization reaction under the reaction condition that the temperature was room temperature, the time was 48 hours, and the stirring rate was 500 rpm. The product of the graft polymerization reaction was dried at 85° C. for 24 hours, and subsequently pulverized to prepare the flocculating agent S1.

### Example 2

(1) 100 g of 2-acrylamido-2-methylpropane sulfonic acid, 25 g of dimethyl diallyl ammonium chloride, and 13 g of glycidyl methacrylate were dissolved in 500 g of methanol under the condition of room temperature and a stirring rate of 2,000 rpm to obtain solution-a;

(2) the solution-a was placed in a three-port flask, and nitrogen gas was continuously introduced into the three-port flask for 30 min, 0.27 g of azobisisobutyronitrile was then added to carry out a first polymerization reaction under the reaction condition that the temperature was 65° C. the time was 10 hours, and the stirring rate was 500 rpm. The product of the first polymerization reaction was dried at 85° C. for 24 hours, and subsequently pulverized to obtain prepolymer-A;

(3) 10 g of hydroxypropyl cellulose was dissolved in 450 g of methanol under the condition of room temperature and a stirring rate of 2,000 rpm to obtain solution-b;

(4) 100 g of methacrylamide hexadecyl ester, 20 g of acrylamide and 0.75 g of 2-aminoethanethiol hydrochloride were added into solution-b, and mixed under the condition of room temperature and a stirring rate of 2,000 rpm, the mixture was then placed in a three-port flask, nitrogen gas was continuously introduced for 30 min, 0.27 g of azobisisobutyronitrile was subsequently added to perform a second polymerization reaction under the reaction condition that the temperature was 65° C., the time was 14 hours, and the stirring rate was 500 rpm. The product of the second polymerization reaction was dried at 85° C. for 24 hours, and subsequently pulverized to obtain prepolymer-B;

(5) 10 g of prepolymer-A and 10 g of prepolymer-B were weighed (i.e., the mass ratio of prepolymer-A:prepolymer-B was 1:1) and dissolved in 100 g of methanol to carry out a graft polymerization reaction under the reaction condition that the temperature was room temperature, the time was 44 hours, and the stirring rate was 500 rpm. The product of the graft polymerization reaction was dried at 85° C. for 24 hours, and subsequently pulverized to prepare the flocculating agent S2.

### Example 3

(1) 100 g of sodium allylsulfonate, 15 g of acryloxyethyl trimethyl ammonium chloride and 10 g of glycidyl methacrylate were dissolved in 400 g of methanol under the condition of room temperature and a stirring rate of 2,000 rpm to obtain solution-a;

(2) the solution-a was placed in a three-port flask, and nitrogen gas was continuously introduced into the three-port flask for 30 min, 0.25 g of azobisisobutyronitrile was then added to carry out a first polymerization reaction under the reaction condition that the temperature was 60° C., the time was 9 hours, and the stirring rate was 500 rpm. The product of the first polymerization reaction was dried at 85° C. for 24 hours, and subsequently pulverized to obtain prepolymer-A;

(3) 15 g of hydroxypropyl cellulose was dissolved in 500 g of methanol under the condition of room temperature and a stirring rate of 2,000 rpm to obtain solution-b;

(4) 100 g of styrene, 30 g of acrylamide and 0.75 g of 2-aminoethanethiol hydrochloride were added into solution-b, and mixed under the condition of room temperature and a stirring rate of 2,000 rpm, the mixture was then placed in a three-port flask, nitrogen gas was continuously introduced for 30 min, 0.25 g of azobisisobutyronitrile was subsequently added to perform a second polymerization reaction under the reaction condition that the temperature was 70° C., the time was 15 hours, and the stirring rate was 500 rpm. The product of the second polymerization reaction was dried at 85° C. for 24 hours, and subsequently pulverized to obtain prepolymer-B;

(5) 15 g of prepolymer-A and 15 g of prepolymer-B were weighed (i.e., the mass ratio of prepolymer-A:prepolymer-B was 1:1) and dissolved in 100 g of methanol to carry out a graft polymerization reaction under the reaction condition that the temperature was room temperature, the time was 40 hours, and the stirring rate was 500 rpm. The product of the graft polymerization reaction was dried at 85° C. for 24 hours, and subsequently pulverized to prepare the flocculating agent S3.

### Example 4

(1) 100 g of acrylic acid, 40 g of N-2(acrylamido methoxy) ethyl trimethyl ammonium chloride and 20 g of glycidyl methacrylate were dissolved in 500 g of dimethylsulfoxide under the condition of room temperature and a stirring rate of 1,000 rpm to obtain solution-a;

(2) the solution-a was placed in a three-port flask, and nitrogen gas was continuously introduced into the three-port flask for 30 min, 0.4 g of azobisisobutyronitrile was then added to carry out a first polymerization reaction under the reaction condition that the temperature was 85° C., the time was 12 hours, and the stirring rate was 300 rpm. The product of the first polymerization reaction was dried at 85° C. for 24 hours, and subsequently pulverized to obtain prepolymer-A;

(3) 20 g of hydroxypropyl cellulose was dissolved in 500 g of dimethylsulfoxide under the condition of room temperature and a stirring rate of 1,000 rpm to obtain solution-b;

(4) 100 g of styrene, 15 g of acrylamide and 2 g of 2-aminoethanethiol hydrochloride were added into solution-b, and mixed under the condition of room temperature and a stirring rate of 1,000 rpm, the mixture was then placed in a three-port flask, nitrogen gas was continuously introduced for 30 min, 0.4 g of azobisisobutyronitrile was subsequently added to perform a second polymerization reaction under the reaction condition that the temperature was 75° C., the time was 18 hours, and the stirring rate was 300 rpm. The product of the second polymerization reaction was dried at 85° C. for 24 hours, and subsequently pulverized to obtain prepolymer-B;

(5) 10 g of prepolymer-A and 20 g of prepolymer-B were weighed (i.e., the mass ratio of prepolymer-A:prepolymer-B was 1:2) and dissolved in 100 g of methanol to carry out a graft polymerization reaction under the reaction condition that the temperature was room temperature, the time was 32 hours, and the stirring rate was 300 rpm. The product of the graft polymerization reaction was dried at 85° C. for 24 hours, and subsequently pulverized to prepare the flocculating agent S4.

### Example 5

(1) 100 g of acrylic acid, 30 g of vinyl pyridine and 20 g of glycidyl methacrylate were dissolved in 350 g of isopropanol under the condition of room temperature and a stirring rate of 1,000 rpm to obtain solution-a;

(2) the solution-a was placed in a three-port flask, and nitrogen gas was continuously introduced into the three-port flask for 30 min, 0.35 g of dibenzoyl peroxide was then added to carry out a first polymerization reaction under the reaction condition that the temperature was 75° C., the time was 11 hours, and the stirring rate was 300 rpm. The product of the first polymerization reaction was dried at 85° C. for 24 hours, and subsequently pulverized to obtain prepolymer-A;

(3) 20 g of polyvinyl alcohol was dissolved in 350 g of isopropanol under the condition of room temperature and a stirring rate of 1,000 rpm to obtain solution-b;

(4) 100 g of styrene, 35 g of acrylamide and 1.5 g of 2-aminoethanethiol hydrochloride were added into solution-b, and mixed under the condition of room temperature and a stirring rate of 1,000 rpm, the mixture was then placed in a three-port flask, nitrogen gas was continuously introduced for 30 min, 0.35 g of dibenzoyl peroxide was subsequently added to perform a second polymerization reaction under the reaction condition that the temperature was 80° C., the time was 20 hours, and the stirring rate was 300 rpm. The product of the second polymerization reaction was dried at 85° C. for 24 hours, and subsequently pulverized to obtain prepolymer-B;

(5) 10 g of prepolymer-A and 20 g of prepolymer-B were weighed (i.e., the mass ratio of prepolymer-A:prepolymer-B was 1:2) and dissolved in 100 g of isopropanol to carry out a graft polymerization reaction under the reaction condition that the temperature was room temperature, the time was 28 hours, and the stirring rate was 300 rpm. The product of the graft polymerization reaction was dried at 85° C. for 24 hours, and subsequently pulverized to prepare the flocculating agent S5.

### Example 6

(1) 100 g of acrylamide, 10 g of octadecyl dimethyl allyl ammonium chloride, and 5 g of glycidyl methacrylate were dissolved in 300 g of isopropanol under the condition of room temperature and a stirring rate of 2,000 rpm to obtain solution-a;

(2) the solution-a was placed in a three-port flask, and nitrogen gas was continuously introduced into the three-port flask for 30 min, 0.1 g of dibenzoyl peroxide was then added to carry out a first polymerization reaction under the reaction condition that the temperature was 50° C., the time was 8 hours, and the stirring rate was 500 rpm. The product of the first polymerization reaction was dried at 85° C. for 24 hours, and subsequently pulverized to obtain prepolymer-A;

(3) 25 g of polyvinyl alcohol was dissolved in 300 g of isopropanol under the condition of room temperature and a stirring rate of 2,000 rpm to obtain solution-b;

(4) 100 g of vinylcyclohexane, 10 g of acrylamide and 0.35 g of 2-aminoethanethiol hydrochloride were added into solution-b, and mixed under the condition of room temperature and a stirring rate of 2,000 rpm, the mixture was then placed in a three-port flask, nitrogen gas was continuously introduced for 30 min, 0.1 g of dibenzoyl peroxide was subsequently added to perform a second polymerization reaction under the reaction condition that the temperature was 55° C. the time was 11 hours, and the stirring rate was 300 rpm. The product of the second polymerization reaction was dried at 85° C. for 24 hours, and subsequently pulverized to obtain prepolymer-B;

(5) 20 g of prepolymer-A and 20 g of prepolymer-B were weighed (i.e., the mass ratio of prepolymer-A:prepolymer-B was 1:1) and dissolved in 100 g of isopropanol to carry out a graft polymerization reaction under the reaction condition that the temperature was room temperature, the time was 24 hours, and the stirring rate was 500 rpm. The product of the graft polymerization reaction was dried at 85° C. for 24 hours, and subsequently pulverized to prepare the flocculating agent S6.

### Example 7

(1) 100 g of acrylamide, 10 g of acryloxyethyl trimethyl ammonium chloride and 5 g of glycidyl methacrylate were dissolved in 800 g of ethanol under the condition of room temperature and a stirring rate of 1,000 rpm to obtain solution-a;

(2) the solution-a was placed in a three-port flask, and nitrogen gas was continuously introduced into the three-port flask for 30 min, 0.5 g of dibenzoyl peroxide was then added to carry out a first polymerization reaction under the reaction condition that the temperature was 50° C., the time was 7 hours, and the stirring rate was 300 rpm. The product of the first polymerization reaction was dried at 85° C. for 24 hours, and subsequently pulverized to obtain prepolymer-A;

(3) 5 g of polyvinyl alcohol was dissolved in 800 g of ethanol under the condition of room temperature and a stirring rate of 1,000 rpm to obtain solution-b;

(4) 100 g of vinylcyclohexane, 40 g of acrylamide and 0.1 g of 2-aminoethanethiol hydrochloride were added into solution-b, and mixed under the condition of room temperature and a stirring rate of 1,000 rpm, the mixture was then placed in a three-port flask, nitrogen gas was continuously introduced for 30 min, 0.5 g of dibenzoyl peroxide was subsequently added to perform a second polymerization reaction under the reaction condition that the temperature was 45° C., the time was 10 hours, and the stirring rate was 500 rpm. The product of the second polymerization reaction was dried at 85° C. for 24 hours, and subsequently pulverized to obtain prepolymer-B;

(5) 15 g of prepolymer-A and 25 g of prepolymer-B were weighed (i.e., the mass ratio of prepolymer-A:prepolymer-B was 1:1.67) and dissolved in 100 g of ethanol to carry out a graft polymerization reaction under the reaction condition that the temperature was room temperature, the time was 20 hours, and the stirring rate was 500 rpm. The product of the graft polymerization reaction was dried at 85° C. for 24 hours, and subsequently pulverized to prepare the flocculating agent S7.

### Comparative Example 1

The flocculating agent was prepared according to the same method as that in Example 1, except that in step (5), 1 g of prepolymer-A and 10 g of prepolymer-B were weighed (i.e., the mass ratio of prepolymer-A:prepolymer-B was 1:10), such that the flocculating agent D1 was prepared.

### Comparative Example 2

The flocculating agent was prepared according to the same method as that in Example 1, except that the cationic monomer was 2-acetyl-5-bromo-4-methylthiophene, such that the flocculating agent D2 was prepared.

### Test Examples

The oil-based drilling fluids were treated with the flocculating agents prepared in Examples 1-7 and Comparative Examples 1-2 to evaluate the performance of the flocculating agents provided in the present disclosure for removing oil-based drilling fluid rock cuttings. In the following test examples,

The plastic viscosity (mPa·s), the dynamic shear force (Pa), the initial shear force (Pa) and the final shear force (Pa) of the drilling fluids were measured and determined by using a six-speed viscometer according to the method as specified in the Chinese National Standard GB/T16783.2-2012;

The median particle diameter of the solid phase in the drilling fluids was tested by using a focused beam reflection measuring instrument (FBRM, manufactured by METTLER TOLEDO with a model number PARTICLETRACK G600B);

The elements of flocculated solid phase were measured by using an X-ray fluorescence spectrometer (manufactured by Marlvern with a model number ZETIUM);

The density of drilling fluids, the content of low density solid phase and the content of barite solid phase in the drilling fluids were measured according to the method specified in the Chinese National Standard GB/T16783.2-2012, both the content of low density solid phase and the content of barite solid phase referred to the volume content unless otherwise specified;

The six-speed viscometer was manufactured by Qingdao Tongchun Oil Instrument Co., Ltd. with the model number ZNN-D6B;

The low speed blender was manufactured by Qingdao Tongchun Oil Instrument Co., Ltd. with the model number D90.

The centrifuge was manufactured by Hunan XiangYi Laboratory Instrument Development Co., Ltd. with the model number TG16-WS.

Preparation of Oil-Based Drilling Fluid Samples:

The oil-based drilling fluid treated in the test example was derived from the Nanyuan block of Xinjiang, the oil-based drilling fluid had a density of 2.36 g/cm³, the oil-based drilling fluid was subjected to sieving (100 mesh standard sieve) after sampling, so as to screen out the visible rock cuttings and obtain the oil-based drilling fluid sample (after testing, the oil-based drilling fluid sample comprised a low density solid phase in an amount of 18% by volume, and a barite solid phase in an amount of 39% by volume. The volume contents of solid phase were converted into the mass contents of solid phase based on that the density of the low density solid phase was 2.6 g/cm³, and the density of the barite solid phase was 4.2 g/cm³, the mass ratio of the low density solid phase to the barite solid phase in the oil-based drilling fluid sample was about 0.28:1. The low density solid phase mainly included rock cuttings, organic clay, bitumen and the like, given that the content of the organic clay and bitumen in the drilling fluid was extremely low compared to the rock cuttings, it was considered that the low density solid phase was mainly composed of rock cuttings, i.e., the inferior solid phase. Therefore, the mass ratio of the inferior solid phase to the barite solid phase in the oil-based drilling fluid sample can be considered to be about 0.28:1), the sample was subjected to the following tests:

1. The testing of median particle diameter of the solid phase and the testing of rheological properties of the drilling fluid following an addition of the flocculating agent.

100 mL oil-based drilling fluid samples (as base slurries) were respectively added with 1 g of the flocculating agents prepared in Examples 1-7 and Comparative Examples 1-2 of the present disclosure, and the mixture was subjected to blending by using a low speed blender at a rotational speed of 100 r/min for 20 min to carry out the flocculation treatment on the oil-based drilling fluid samples, such that the drilling fluids after the flocculation treatment were obtained (the flocculated drilling fluids corresponding to Examples 1-7 of the present disclosure were denoted as BS1-7, and the flocculated drilling fluids corresponding to Comparative Examples 1-2 were denoted as BD1-2); the median particle diameter of the solid phase and the rheological parameters (plastic viscosity, dynamic shear force, initial shear force and final shear force) of the drilling fluids following the flocculation treatment were respectively measured.

The test results were shown in Table 1.

TABLE 1

| | Median particle | | | Gel strength |
|---|---|---|---|---|
| | diameter of the | Plastic | Yield | values (10 s |
| | solid phase/ | viscosity/ | point/ | and 10 min)/ |
| Test objects | μm | mPa · s | Pa | Pa |
| Oil-based drilling | 12 | 76 | 26 | 6/32 |
| fluid sample (base | | | | |
| slurry) | | | | |
| BS1 | 112 | 61 | 18 | 5/15 |
| BS2 | 103 | 64 | 23 | 4/16 |
| BS3 | 98 | 64 | 21 | 4/18 |
| BS4 | 82 | 63 | 23 | 5/21 |
| BS5 | 65 | 69 | 23 | 5/22 |
| BS6 | 62 | 71 | 26 | 5/22 |
| BS7 | 79 | 67 | 23 | 4/21 |
| BD1 | 31 | 79 | 26 | 6/32 |
| BD2 | 15 | 82 | 29 | 6/34 |

As can be seen from Table 1, after the oil-based drilling fluid samples (base slurries) were added with the flocculating agent provided by the present disclosure to carry out the flocculation treatment, the median particle diameter of the solid phase of the drilling fluids was significantly increased from 12 μm to 60 μm or more, wherein the Examples 1-3 exhibited the significantly better effect, the median particle diameter of the solid phase of the drilling fluids was increased to 95 μm or more. It indicated that the flocculating agent provided by the present disclosure had a significant flocculation effect on micro-nanometer scale fine rock cuttings in the oil-based drilling fluid samples (base slurries), thereby significantly increasing the median particle diameter of the solid phase of the drilling fluids. While the method and flocculating agent provided by the present disclosure were not used in the Comparative Examples, the median particle diameters of the solid phase of the flocculated oil-based drilling fluids were significantly lower than those of Examples 1-7, wherein the Comparative Example 1 did not use the specific ratio relationship of prepolymer-A to prepolymer-B of the present disclosure, the flocculation effect of the prepared flocculating agent was not desirable; the Comparative Example 2 used 2-acetyl-5-bromo-4-methylthiophene as a cationic monomer, and the flocculation effect of the prepared flocculating agent was weak, resulting in the oil-based drilling fluid sample BD2 having a median particle diameter of the solid phase being proximate with the median particle diameter of the solid phase of the oil-based drilling fluid sample (base slurry).

In terms of the rheological properties of the drilling fluids, after the oil-based drilling fluid samples (base slurries) were added with the flocculating agent provided by the present disclosure to carry out the flocculation treatment, the plastic viscosity and the 10-min-gel strength of the drilling fluids were significantly reduced, which also reflected that the rock cuttings in the samples had been flocculated into large particles.

2. The testing of flocculated solid phase components after adding the flocculating agents into the drilling fluids.

The aforementioned drilling fluids BS1-7 and BD1-2 were subjected to sieving (100-mesh standard sieve), the conditions of sieve surface were recorded, and the floccules retained on the sieve surface were washed with n-hexane, and then dried at 50° C. to obtain the flocculated solid phases.

The elements of the flocculated solid phases was subjected to testing to measure the percentage contents by mass of oxides (SiO₂, CaO, BaO, Al₂O₃, Fe₂O₃) and further converted by molecular weight to obtain the percentage contents by mass of barite (BaSO₄), calcia (CaO), and inferior solid phase in the flocculated solid phases (where the percentage content by mass of inferior solid phase=100%−the percentage content by mass of barite−the percentage content by mass of calcia), the results were shown in Table 2.

TABLE 2

| | Content | | Content of | |
|---|---|---|---|---|
| | of barite/ | Content of | inferior solid | Conditions of |
| Test objects | wt % | CaO/wt % | phase/wt % | sieve surface |
| Flocculated solid | / | / | / | Solid phase was |
| phase of the oil- | | | | not shown on |
| based drilling | | | | the sieve |
| fluid sample | | | | surface |
| (base slurries) | | | | |
| Flocculated solid | 25.24 | 10.85 | 63.91 | Many solid |
| phase of BS1 | | | | phase on the |
| | | | | sieve surface |
| | | | | with a large |
| | | | | particle size of |
| | | | | the floccules |
| Flocculated solid | 26.74 | 10.12 | 63.14 | Many solid |
| phase of BS2 | | | | phase on the |
| | | | | sieve surface |
| | | | | with a large |
| | | | | particle size of |
| | | | | the floccules |
| Flocculated solid | 24.45 | 12.64 | 62.91 | Many solid |
| phase of BS3 | | | | phase on the |
| | | | | sieve surface |
| | | | | with a large |
| | | | | particle size of |
| | | | | the floccules |
| Flocculated solid | 31.44 | 10.56 | 58.0 | Many solid |
| phase of BS4 | | | | phase on the |
| | | | | sieve surface |
| | | | | with a medium |
| | | | | particle size of |
| | | | | the floccules |
| Flocculated solid | 31.79 | 11.24 | 56.97 | Many solid |
| phase of BS5 | | | | phase on the |
| | | | | sieve surface |
| | | | | with a medium |
| | | | | particle size of |
| | | | | the floccules |
| Flocculated solid | 34.47 | 10.74 | 54.79 | Many solid |
| phase of BS6 | | | | phase on the |
| | | | | sieve surface |
| | | | | with a medium |
| | | | | particle size of |
| | | | | the floccules |
| Flocculated solid | 34.68 | 10.98 | 54.34 | Many solid |
| phase of BS7 | | | | phase on the |
| | | | | sieve surface |
| | | | | with a medium |
| | | | | particle size of |
| | | | | the floccules |
| Flocculated solid | 68.21 | 13.68 | 18.11 | The sieve |
| phase of BD1 | | | | surface merely |
| | | | | had a small |
| | | | | amount of solid |
| | | | | phase with tiny |
| | | | | particle size |
| Flocculated solid | / | / | / | The solid phase |
| phase of BD2 | | | | was not shown |
| | | | | on the sieve |
| | | | | surface, which |
| | | | | merely has a |
| | | | | small amount of |
| | | | | gel |

As can be seen from Table 2, after the oil-based drilling fluid samples (base slurries) were added with the flocculating agent provided by the present disclosure to carry out the flocculation treatment, the content of inferior solid phase in the obtained flocculated solid phase was higher than 50 wt %, and a mass ratio of the inferior solid phase to the barite solid phase was more than 1.5:1. While the mass ratio of the inferior solid phase to the barite solid phase in the oil-based drilling fluid samples (base slurries) was about 0.28:1. As can be seen, the flocculating agent provided by the present disclosure can provide desirable effect of selectively flocculating the inferior solid phase, the flocculating agent had a relatively weak flocculation effect on the barite, such that the oil-based drilling fluids following the flocculation treatment can maintain desired service performance. It should be noted that more than 20 wt % barite can still be measured from the flocculated solid phase of BS1-7 in the testing, the reason was that the drilling fluids were unavoidably adsorbed on the surface of the flocculated solid phase during a process of subjecting the flocculated drilling fluids to the sieving treatment, after washing with n-hexane, the solid phase (including barite) in the adsorbed drilling fluids was retained in the flocculated solid phase. The adsorption factor was the main source of barite fraction in the flocculated solid phase, as a result, the percentage content by mass of the barite flocculated by the flocculating agent was significantly lower than the content of barite as shown in Table 2, that is, the flocculating agent provided by the present disclosure had a relatively weak flocculation effect on the barite.

The method and flocculating agent provided by the present disclosure were not used in the Comparative Examples, thus the selective flocculation effect of the Comparative Examples on inferior solid phase in oil-based drilling fluids was significantly inferior to that of the Examples 1-7. Among them, the content of inferior solid phase was lower than 20 wt % and the content of useful solid phase (barite and calcia) was higher than 80 wt % in the flocculated phase of the Comparative Example 1, which indicates that its flocculation effect on the inferior solid phase was not desirable, a large amount of the useful solid phase was flocculated, such that the service performance of the oil-based drilling fluids was seriously affected. Comparative Example 2 failed to obtain flocculated solid phase on the sieve surface due to its weak flocculation effect, let alone the selective flocculation effect on the inferior solid phase.

3. The measurement of centrifugate density and the content of inferior solid phase in centrifugate of the drilling fluids following an addition of the flocculating agent.

The above drilling fluids BS1-7 and BD1-2 were transferred into a centrifuge tube, and centrifuged at a rotational speed of 4,800 r/min by using a centrifuge for 10 min, the upper centrifugate after the centrifugation was taken, the density of the centrifugate and the content of inferior solid phase in the centrifugate were measured. The measurement results were shown in Table 3.

TABLE 3

| | Density/ | Content of inferior |
|---|---|---|
| Test objects | g · cm³ | solid phase/% |
| Centrifugate of the oil-based drilling | 1.49 | 14.8 |
| fluid sample (base slurry) | | |
| Centrifugate of BS1 | 1.21 | 6.2 |
| Centrifugate of BS2 | 1.24 | 7.4 |
| Centrifugate of BS3 | 1.24 | 7.1 |
| Centrifugate of BS4 | 1.31 | 9.3 |
| Centrifugate of BS5 | 1.34 | 11.1 |
| Centrifugate of BS6 | 1.35 | 12.3 |
| Centrifugate of BS7 | 1.32 | 9.7 |
| Centrifugate of BD1 | 1.48 | 14.1 |
| Centrifugate of BD2 | 1.52 | 16.3 |

As illustrated in Table 3, the centrifugate density of the drilling fluids BS1-7 is significantly lower than the centrifuge density of the oil-based drilling fluid sample (base slurry), and the content of inferior solid phase in the centrifugate of the drilling fluids BS1-7 is also significantly lower than the content of inferior solid phase in the centrifugate of the oil-based drilling fluid sample (base slurry), it indicated that the flocculating agent provided by the present disclosure produced excellent flocculation effect in the oil-based drilling fluids, the flocculating agent can significantly promote flocculation and agglomeration of the inferior solid phase particles in the drilling fluids, such that the inferior solid phase particles can be easily separated out during the centrifugation process, and ultimately resulted in a significantly lower centrifugate density of flocculated drilling fluid and the content of inferior solid phase in the centrifugate.

Both the centrifugate density and the content of inferior solid phase in the centrifugate of drilling fluids BD1 and BD2 are significantly higher than those of drilling fluids BS1-7, it indicates that the flocculation effects of Comparative Examples 1-2 are significantly inferior to those of the flocculating agents provided by Examples 1-7 of the present disclosure. It shall be noted that the centrifugate density and the content of inferior solid phase in the centrifugate of drilling fluid BD2 are higher than those of oil-based drilling fluid sample (base slurries) without adding a flocculating agent, because the addition of the flocculating agent D2 causes a significant improvement in the shear viscosity of the obtained drilling fluid BD2 compared to the oil-based drilling fluid sample (base slurries), such that the separation of the inferior solid phase during centrifugation becomes more difficult.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1. A flocculating agent for removing oil-based drilling fluid rock cuttings prepared from a prepolymer-A and a prepolymer-B through a graft polymerization reaction in the presence of a third solvent;
wherein the prepolymer-A is prepared by subjecting a hydrophilic monomer, a cationic monomer and glycidyl methacrylate to a first polymerization reaction in the presence of a first solvent and a first initiator; and
the prepolymer-B is prepared by subjecting an oil-soluble monomer, acrylamide and 2-aminoethanethiol hydrochloride to a second polymerization reaction in the presence of a dispersing agent, a second solvent and a second initiator.

2. The flocculating agent of claim 1, wherein the mass ratio of prepolymer-A:prepolymer-B is 1:(1-5);
the mass ratio of (prepolymer-A+prepolymer-B):the third solvent is (1-4):10.

3. The flocculating agent of claim 2, wherein the raw materials for preparing prepolymer-A meet the following condition: the cationic monomer is 10-40 parts by weight, the glycidyl methacrylate is 5-20 parts by weight, the first solvent is 300-800 parts by weight, the first initiator is 0.1-0.5 parts by weight, based on 100 parts by weight of the hydrophilic monomer; the raw materials for preparing prepolymer-B meet the following condition: acrylamide is 10-40 parts by weight, 2-aminoethanethiol hydrochloride is 0.1-2 parts by weight, the second solvent is 300-800 parts by weight, the dispersing agent is 5-25 parts by weight, the second initiator is 0.1-0.5 parts by weight, based on 100 parts by weight of the oil-soluble monomer.

4. The flocculating agent of claim 3, wherein the raw materials for preparing prepolymer-A meet the following condition: the cationic monomer is 15-25 parts by weight, the glycidyl methacrylate is 10-15 parts by weight, the first solvent is 400-550 parts by weight, the first initiator is 0.25-0.3 parts by weight, based on 100 parts by weight of the hydrophilic monomer; the raw materials for preparing prepolymer-B meet the following condition: acrylamide is 20-30 parts by weight, 2-aminoethanethiol hydrochloride is 0.5-1 parts by weight, the second solvent is 400-550 parts by weight, the dispersing agent is 10-15 parts by weight, the second initiator is 0.25-0.3 parts by weight, based on 100 parts by weight of the oil-soluble monomer.

5. The flocculating agent of claim 1, wherein the oil-soluble monomer is at least one selected from the group consisting of styrene, vinylcyclohexane and methacrylamide hexadecyl ester;
the cationic monomer is at least one selected from the group consisting of N-2(acrylamido methoxy) ethyl trimethyl ammonium chloride, methacryloxyethyl trimethyl ammonium chloride, acryloxyethyl trimethyl ammonium chloride, dimethyl diallyl ammonium chloride, vinyl pyridine and octadecyl dimethyl allyl ammonium chloride;
the hydrophilic monomer is at least one selected from the group consisting of acrylamide, acrylic acid, sodium allylsulfonate and 2-acrylamido-2-methylpropane sulfonic acid.

6. The flocculating agent of claim 5, wherein the oil-soluble monomer is methacrylamide hexadecyl ester and/or styrene;
the cationic monomer is acryloxyethyl trimethyl ammonium chloride and/or dimethyl diallyl ammonium chloride;
the hydrophilic monomer is 2-acrylamido-2-methylpropane sulfonic acid and/or sodium allylsulfonate.

7. The flocculating agent of claim 1, wherein the first solvent and the second solvent are the same, each is selected from methanol, ethanol, dimethylsulfoxide or isopropanol;
the third solvent is selected from methanol, ethanol or isopropanol;
the dispersing agent is selected from hydroxypropyl cellulose or polyvinyl alcohol;
the first initiator and the second initiator are the same, each is selected from azobisisobutyronitrile or dibenzoyl peroxide.

8. A method of preparing the flocculating agent of claim 1 comprising:
(1) subjecting a hydrophilic monomer, a cationic monomer, and glycidyl methacrylate to a first dissolution with a first solvent to obtain solution-a;
(2) adding a first initiator into the solution-a for performing a first polymerization reaction to obtain prepolymer-A;
(3) subjecting the dispersing agent to a second dissolution with a second solvent to obtain solution-b;
(4) adding an oil-soluble monomer, acrylamide and 2-aminoethanethiol hydrochloride into the solution-b and mixing the compounds, then adding a second initiator to perform a second polymerization reaction to obtain prepolymer-B;
(5) dissolving the prepolymer-A and the prepolymer-B in a third solvent to perform a graft polymerization reaction to produce a flocculating agent.

9. The method of claim 8, wherein the condition of the first dissolution in step (1) comprises a temperature of room temperature, and a stirring rate within a range of 1,000-2,000 rpm.

10. The method of claim 9, wherein the condition of the first polymerization reaction in step (2) comprises a temperature of 50-85° C., a time of 7-12 h, and a stirring rate within a range of 300-500 rpm.

11. The method of claim 8, wherein the condition of the second dissolution in step (3) comprises a temperature of room temperature, and a stirring rate within a range of 1,000-2,000 rpm.

12. The method of claim 11, wherein the condition of mixing in step (4) comprises a temperature of room temperature, and a stirring rate within a range of 1,000-2,000 rpm; the condition of the second polymerization reaction comprises a temperature of 45-80° C., a time of 10-24 hours, and a stirring rate within a range of 300-500 rpm.

13. The method of claim 8, wherein the condition of the graft polymerization reaction comprises a temperature of room temperature, a time of 20-48 h, and a stirring rate within a range of 300-500 rpm.

14. A method of treating an oil-based drilling fluid, said method comprising contacting the flocculating agent of claim 1 with the oil-based drilling fluid containing cutting rocks, so as to form an aggregate of the cutting rocks.

15. The method of claim 14, further comprising removing the aggregate of the cutting rocks from the oil-based drilling fluid.
